(19) United States
(12) Patent Application Publication
(10) Pub. No.: US 2016/0099519 A1
(43) Pub. Date: Apr. 7, 2016

(54) SECURITY DEVICE

(71) Applicant: MULTPLX LIMITED, Kingston Upon Thames (GB)

(72) Inventor: Adam Theobald, London (GB)

(21) Appl. No.: 14/890,764

(22) PCT Filed: May 20, 2014
(86) PCT No.: PCT/EP2014/060309

§ 371 Date: Nov. 12, 2015

(30) Foreign Application Priority Data
May 22, 2013 (GB) 1309246.5

(51) Int. Cl. H01R 13/629; E05B 73/00

(52) U.S. Cl. CPC H01R 13/629; E05B 73/0017; E05B 73/0047

(57) ABSTRACT

A security device for securing a jack plug during retail display of a product, such as a pair of headphones, that is fitted with a jack plug. The security device comprises a jack plug socket for engagement with the jack plug of the product and operable to lock the jack plug so as to prevent withdrawal of the jack plug from the jack plug socket. In addition, the security device has an input for receiving electrical signals from a source, such as an MP3 player or a mobile phone. The input is electrically connected to the jack plug socket so that electrical signals received at the input are transmitted to the jack plug socket. In addition, the security device is provided with an attachment for attaching the security device to a fixture such as a retail display.

### BACKGROUND

The invention relates to a security device for securing a jack plug during retail display of a product fitted with a jack plug.

One type of retail product that is fitted with a jack plug is a pair of headphones. During retail display of a pair of headphones, it is desirable to allow a potential customer to listen to music through the headphones so that the customer can assess the sound quality. The customer may wish, for example, to plug the headphones into his or her MP3 player or mobile phone so that the customer can listen, through the headphones, to music with which the customer is familiar

When allowing customers to try out headphones as described above, it is also desirable to secure the headphones to a fixture, such as a display stand, so that the headphones cannot be stolen.

### SUMMARY

In accordance with a first aspect of the invention, there is provided a security device for securing a jack plug during retail display of a product fitted with a jack plug, the security device comprising: a jack plug socket for engagement with a jack plug and operable to lock a jack plug in said engagement so as to resist withdrawal of the jack plug, an input for receiving electrical signals, the input being electrically connected to the jack plug socket so that electrical signals received at the input are transmitted to the jack plug socket for transmission of the electrical signals from the jack plug socket to a jack plug locked in engagement with the jack plug socket and for onward transmission of the electrical signals to a product connected to the jack plug, and an attachment for attaching the security device to a fixture.

Accordingly, the security device of the current invention allows a retail product to be secured by securing the jack plug connected to the product. It will be appreciated that the security device can be used with other retail products fitted with a jack plug. The use is not limited to pairs of headphones.

The term “jack plug” is used to signify an electrical male plug having a single, generally cylindrical pin provided with a plurality of contact areas along its length and the term “jack plug socket” is used to refer to the corresponding female socket. Jack plugs are also commonly known as audio jacks or phone jacks. The term jack plug includes all sizes (e.g. with 2.5 mm, 3.5 mm and 6.35 mm diameter pins). The term jack plug also covers plugs with any plural number of contacts. For example, an audio stereo jack plug commonly has three contacts and is often referred to as a TRS plug (the initials TRS referring to the three contact areas of the pin known as Tip, Ring and Sleeve). An audio mono jack plug commonly has two contacts and is often referred to as a TS (Tip, Sleeve) plug. A four contact plug is commonly referred to as a TRRS (Tip, Ring, Ring, Sleeve) plug. Jack plugs having greater numbers of contacts are available. All such plugs are included within the term “jack plug” and the corresponding jack plug sockets are included within the term “jack plug socket”. The terms “jack plug” and “jack plug socket” are not limited to audio plugs and sockets and also cover all other uses, such as a microphone plug having a cylindrical configuration and the corresponding socket. In general, the tip of a jack plug is separated from ring and sleeve contacts on the jack plug by a neck. The tip generally includes a convex frusto-conical surface which faces generally radially outwardly and rearwardly (ie towards a handle portion of the jack plug).

Preferably, the security device includes a housing. The jack plug socket is provided in the housing and the attachment allows attachment of the housing to a fixture. In this way, the housing protects and hides the locking mechanism of the jack plug socket.

Preferably, the jack plug socket comprises a locking member which is moveable between a locking position and a release position. When the locking member is in the release position, the jack plug can be withdrawn from the jack plug socket. The locking member is lockable in the locking position to lock the jack plug within the jack plug socket. When the locking member is in the locking position, the locking member engages a tip of a jack plug. In this case, the shape of the tip of the jack plug allows the locking member to achieve purchase on the jack plug. In this way, locking of the jack plug within the jack plug socket can generally be achieved without deforming the pin of the jack plug.

Where the jack plug socket has a locking member as described above, the locking member preferably has a concave frusto-conical surface. In this case, the security device is used with a jack plug having a tip which has a convex frusto-conical surface. By providing the locking member with a concave frusto-conical surface which corresponds closely in shape to the convex frusto-conical surface of the tip of the pin of a jack plug, it has been found possible to achieve secure locking of a jack plug within a jack plug socket.

Where a locking member is provided, the jack plug socket preferably also comprises a rotatable control member which interacts with the locking member. The rotatable control member is rotatable between a first stop at which the locking member is locked in the locking position and a second stop at which the locking member is in the release position. The provision of the two distinct stops is advantageous compared to, for example, a locking screw which can be tightened or loosened without any distinct stops to limit its rotation. The provision of these stops avoids over tightening.

Where the jack plug socket comprises both a locking member and a rotatable control member, as described above, the locking member preferably has a first end and a second end. The first end is pivoted and the second end of the locking member interacts with the rotatable control member to control movement of the locking member between the locking position and the release position. Where a concave frusto-conical surface is provided on the locking member, this is preferably intermediate the first and second ends of the locking member. In this way, a high degree of positional accuracy of the frusto-conical surface may be achieved.

When the jack plug socket is provided with a rotatable control member, the security device preferably also includes a security key. The rotatable control member has a formation which is shaped for engagement with the security key so that the rotatable control member can be rotated by the security key between the first and second stops. Even more preferably, the shape of the formation on the rotatable control member is such that it cannot be engaged by a screwdriver with a slot head or a cross-head. In this way, even if a potential customer is able to gain access to the jack plug socket, the customer may not be able to release the jack plug without a security key which corresponds to the formation on the rotatable control member.

The input of the security device may be any suitable input. It could, for example, be a standard jack plug socket without a locking function. It could also be, for example, a standard USB socket. In one specific embodiment, the input is itself a jack plug which a potential customer can plug into his or her MP3 player or mobile phone.

In accordance with a second aspect of the invention, there is provided a method of securing a jack plug during retail display of a product fitted with a jack plug, comprising providing a product fitted with a jack plug, providing a security device, securing the security device to a fixture, locking the jack plug in engagement with the security device, and providing an input. The input being electrically connected to the jack plug so that electrical signals received at the input are transmitted to the jack plug for onward transmission of the electrical signals to the product.

### BRIEF DESCRIPTION OF THE DRAWINGS

The following is a more detailed description of embodiments of the invention, by way of example, reference being made to the following schematic drawings in which:

FIG. 1 is an isometric view of a security device from which an external lid and an intermediate lid have been omitted in order to show the internal components;

FIG. 2 is a plan view from above of the security device of FIG. 1;

FIG. 3 is a cross-sectional view of the security device of FIGS. 1 and 2;

FIGS. 4 to 8 are isometric views showing components of a jack plug socket of the security device of FIGS. 1 to 3;

FIG. 9 is a plan view from above of the security device of FIGS. 1 to 8 showing an intermediate cover in place in the security device;

FIG. 10 is a plan view from above of the security device of FIGS. 1 to 9 showing an outer cover in place on the security device.

### DETAILED DESCRIPTION

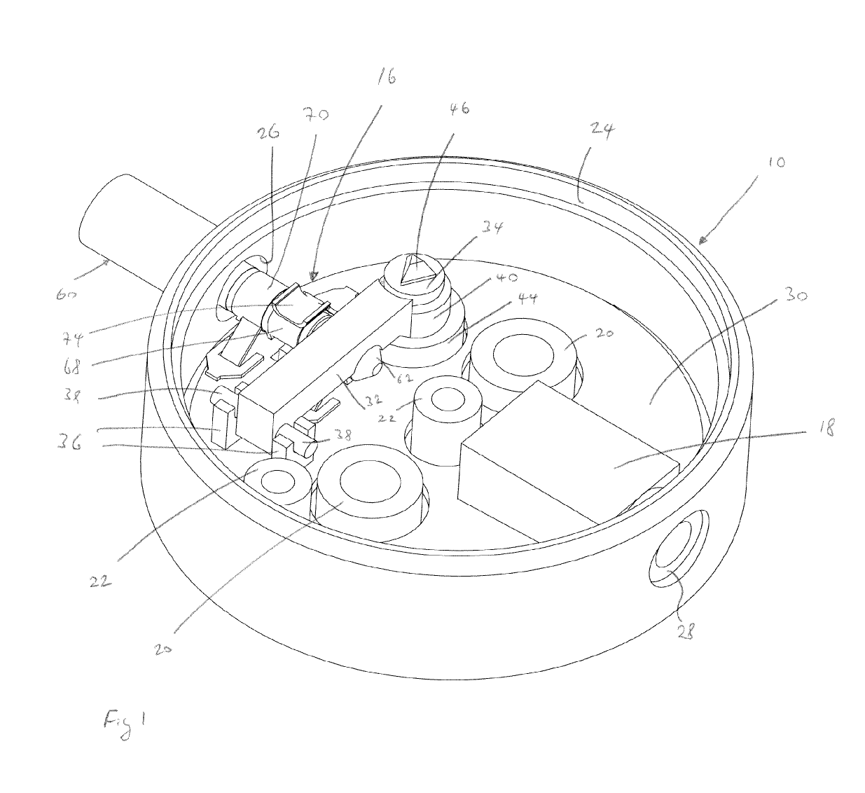

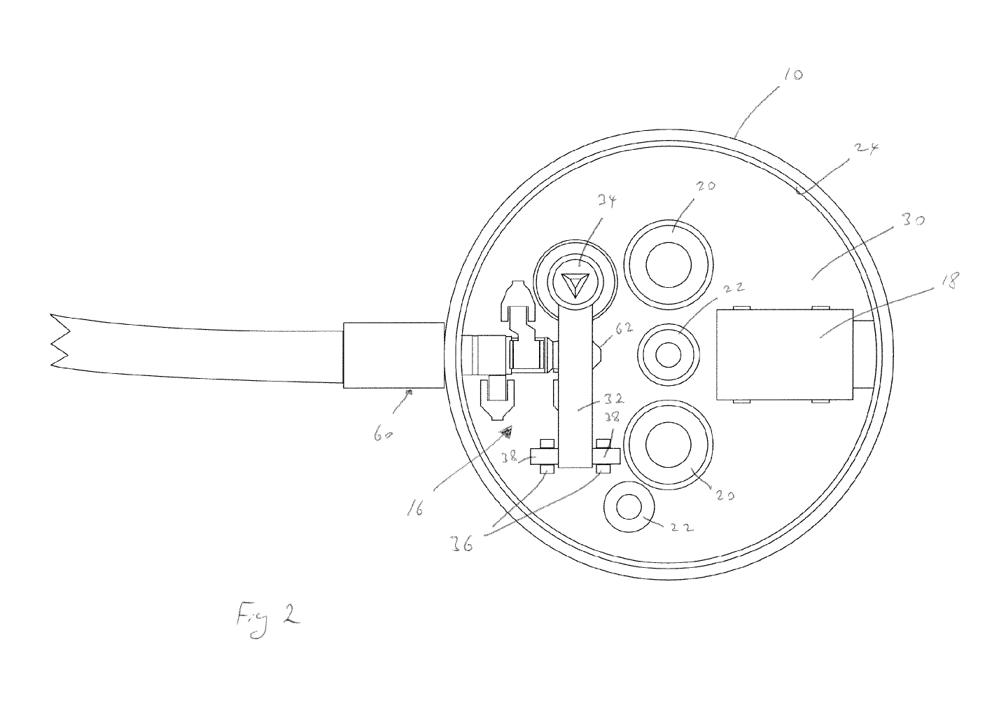

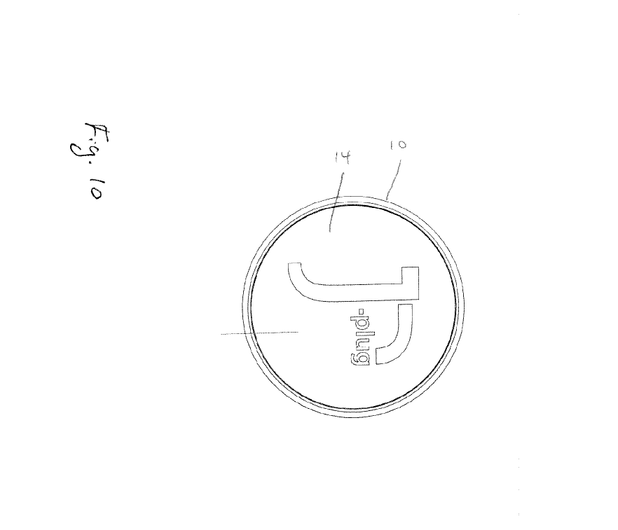

Looking first at FIGS. 1, 2, 9 and 10, the security device includes a casing bottom 10, an intermediate lid 12, an outer lid 14, a locking jack plug socket generally shown at 16, and an input in the form of a standard jack plug socket 18.

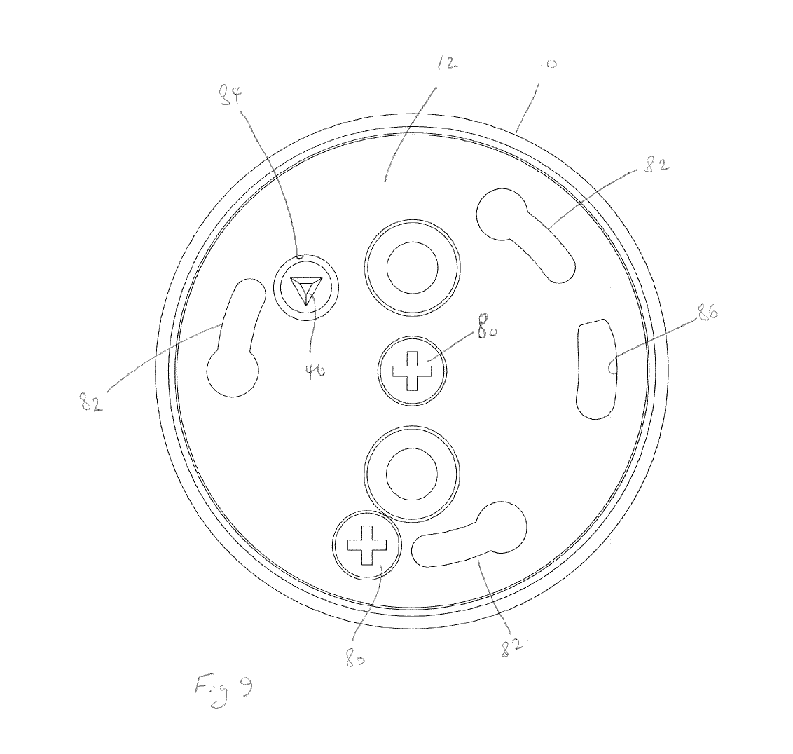

As best seen in FIG. 1, the casing bottom 10 is provided with two upstanding attachment bosses 20. Each attachment boss 20 has a central hole which passes through the casing bottom 10. In this way, the attachment bosses 20 can be used to attach the casing bottom 10 to a fixture, such as a wooden display stand, by passing two screws through the attachment bosses 20 into the underlying wooden fixture. In addition, the casing bottom 10 is provided with two upstanding support bosses 22. Each support boss 22 is provided with a blind threaded hole which, as seen best in FIG. 9, receives a threaded bolt so as to attach the intermediate lid 12 to the casing bottom 10. The casing bottom 10 also has an L-shaped rebate 24 which extends around the casing bottom 10 and which receives the outer lid 14 as described below in more detail.

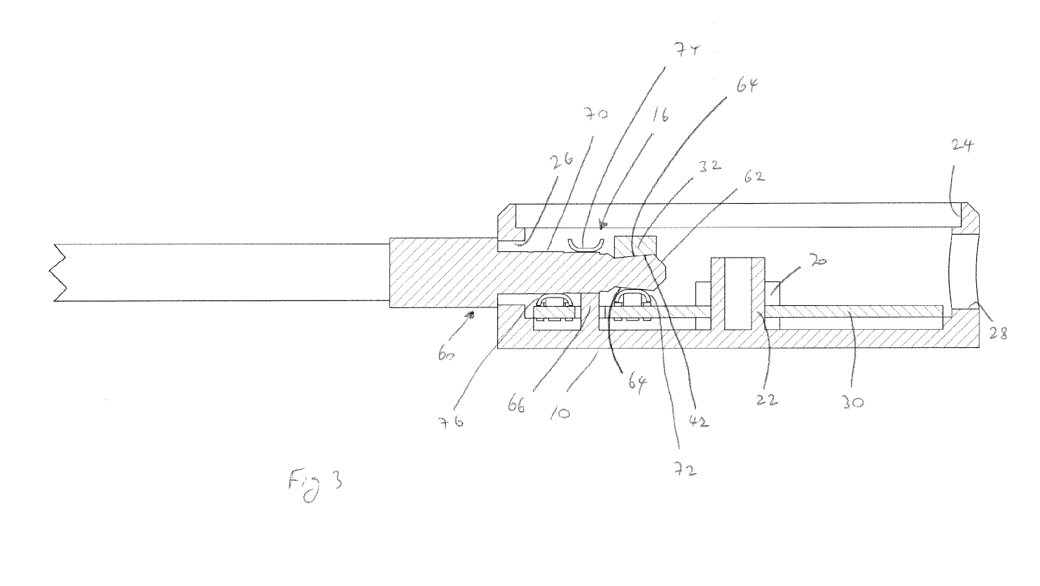

As best seen in FIGS. 1 and 3, the casing bottom 10 also has a first aperture 26 which receives the pin of a jack plug to be engaged in the locking jack plug socket 16 and a second aperture 28 which receives the pin of a jack plug to be engaged in the standard jack plug socket 18. The standard jack plug socket 18 is omitted from FIG. 3 for the purposes of clarity.

Looking now at FIGS. 1 and 3, a connection plate 30 is provided near to but spaced from a bottom wall of the casing bottom 10. The locking jack plug socket 16 and the standard jack plug socket 18 are both mounted on the connection plate 30. Electrical connections (not shown) are provided on the underside of the connection plate 30 to connect the locking jack plug socket 16 with the standard jack plug socket 18. In this way, electrical input signals provided to the standard jack plug socket 18 by a jack plug inserted in the standard jack plug socket 18 are transmitted to the locking jack plug socket 16 so that the locking jack plug socket 16 can transmit the electrical signals to a jack plug engaged with the locking jack plug socket 16.

The standard jack plug socket 18 is conventional in design and will not be described in detail.

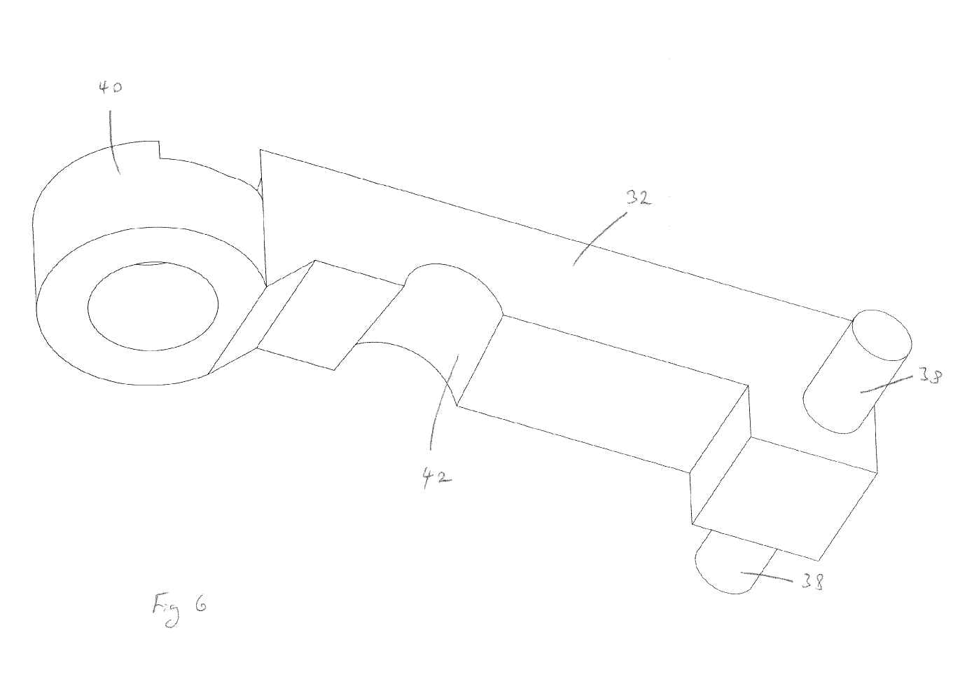

Referring now to FIGS. 1 to 8, the locking jack plug socket 16 includes a locking arm 32, a control screw 34 and a pair of pivot mounts 36. The locking arm 32 is best seen in FIG. 6 which shows the underside of the locking arm 32. As shown in FIG. 6, a first end of the locking arm 32 is provided with a pair of pivot pins 38. As shown in FIG. 1, the pair of pivot pins 38 co-operate with the pivot mounts 36 to allow the locking arm 32 to pivot around the axes of the pivot pins 38. As seen in FIG. 1, the pivot mounts 36 do not prevent upward movement of the pivot pins 38 out of engagement with the pivot mounts 36. However, two projections (not shown) are provided on the underside of the intermediate lid 12 so that when the intermediate lid 12 is fixed to the casing bottom 10 as described above, the projections on the underside of the intermediate lid 12 bear against the pair of pivot pins 38 and prevent any upward movement of the pivot pins 38. In this way, the locking arm 32 is constrained so that only pivoting movement around the axes of the pivot pins 38 is allowed.

The second end of the locking arm 32 is provided with a locking ring 40. The locking ring 40 cooperates with the control screw 34, as described below, to achieve movement of the locking arm 32 between a locking position and a release position.

As shown in FIG. 6, the underside of the locking arm 32 is provided with a frusto-conical recess 42. This serves a purpose described below.

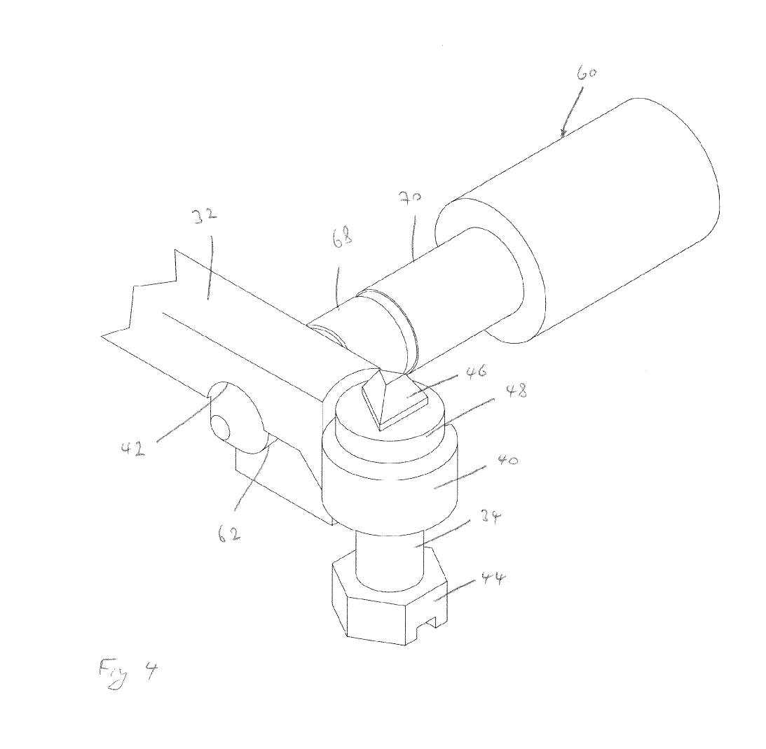

The control screw 34 is best seen in FIGS. 1, 4, 5, 7 and 8. As seen, for example, in FIGS. 1 and 4, the locking screw 34 is engaged, by way of corresponding screw threads, with a nut 44 which is fixed to the bottom wall of the casing bottom 10. In this way, if the control screw 34 is rotated in a clockwise direction (as seen from above), the control screw 34 moves downwardly into the nut 44. If the control screw 34 is rotated in an anti-clockwise direction (as seen from above), then the control screw 34 moves upwardly relative to the nut 44.

The top end of the control screw 34 is provided with a security formation in the form of a truncated pyramid 46. This truncated pyramid 46 is shaped so as to engage with a security key (not shown). The security key is used to rotate the control screw 34 either in a clockwise or anti-clockwise direction.

Immediately below the truncated pyramid 46, the control screw 34 is provided with a locking disc 48. The locking disc 48 cooperates with the locking ring 40 of the locking arm 32 to control movement of the locking arm 32 between a locking position and a release position, as will now be described.

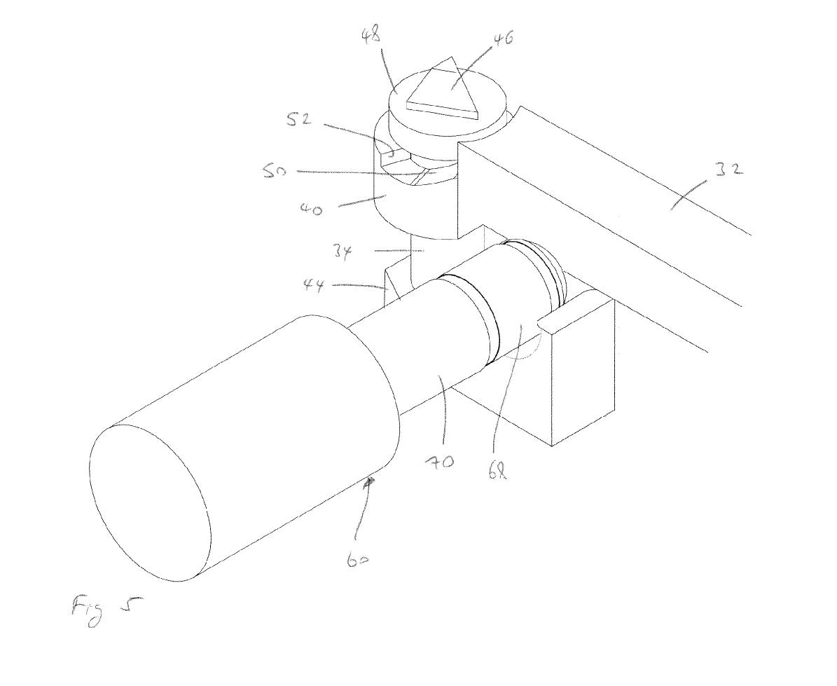

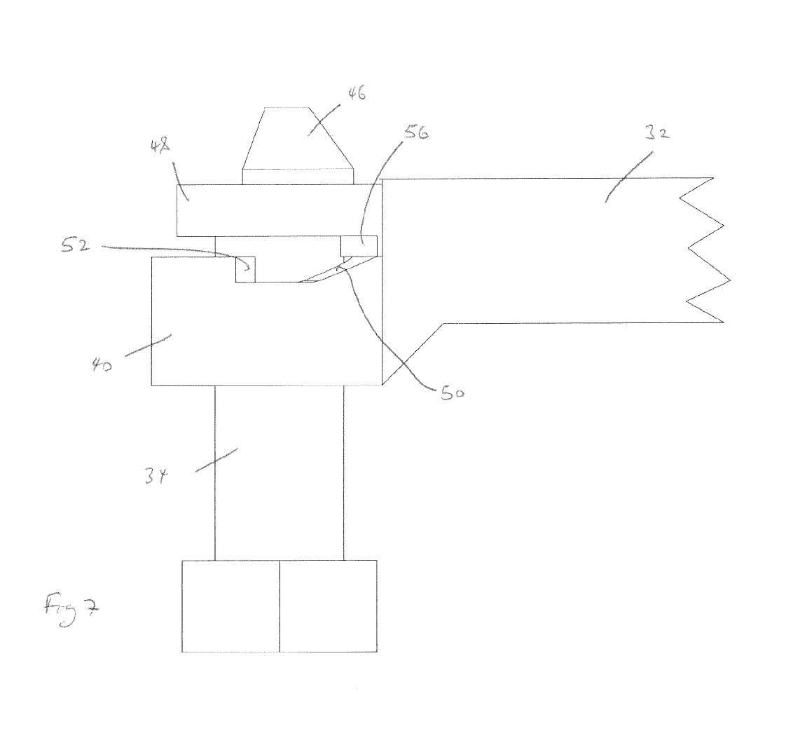

As best seen in FIGS. 5 and 7, the locking ring 40 of the locking arm 32 has, on its upper surface, a cam surface 50. Adjacent to the cam surface 50, the locking ring 40 of the locking arm 32 also has a stop surface 52.

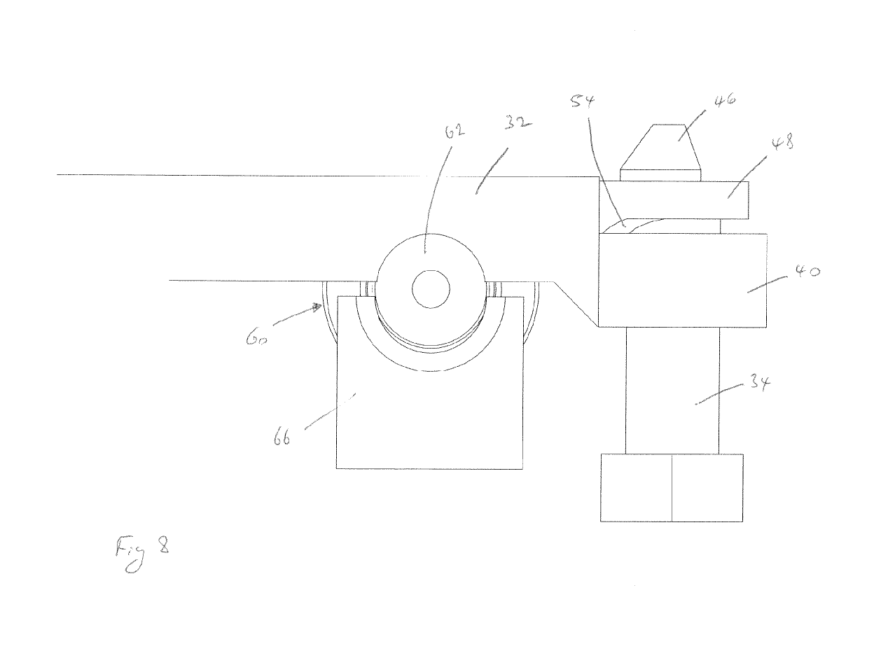

As best seen in FIG. 8, the underside of the locking disc 48 of the control screw 34 also has a cam surface 54. Adjacent to cam surface 54, the locking disc 48 of the control screw 34 has a stop surface 56 which can be seen in FIG. 7.

FIGS. 5, 7 and 8 show the locking arm 32 in a release position. FIGS. 5 and 8 also show a jack plug 60 which is engaged with, but not locked with, the locking jack plug socket 16. In the release position of the locking arm 40, as shown in FIGS. 5, 7 and 8, the jack plug 60 can be withdrawn from the locking jack plug socket 16 simply by pulling the jack plug 60 out of the locking jack plug socket 16.

However, the security key (not shown) can be engaged with the truncated pyramid 46 of the control screw 34 and the security key is then used to rotate the control screw 34 in a clockwise direction (as seen from above). This causes the control screw 34 and the locking disc 48 to move downwardly into/towards the nut 44. During this process, the cam surface 54 on the locking disc 48 moves against and along the cam surface 50 on the locking ring 40 of the locking arm 32. The engagement of the two cam surfaces 50, 54 and the downward movement of the control screw 34, moves the locking arm 32 downwardly from the position shown in FIG. 8. The distance of movement is relatively small.

This process continues until the stop surface 56 on the locking disc 48 of control screw 34 contacts the stop surface 52 on the locking ring 40 of the locking arm 32. After contact between the two stop surfaces 52, 56 no further clockwise motion of the control screw 34 is possible. At this point, the locking arm 32 is in the locking position, and this is shown in FIG. 3.

As seen in FIG. 3, the jack plug 60 is of conventional design and has a jack plug tip shown at 62. The jack plug tip 62 has a convex frusto-conical surface indicated at 64. In the current locking position of the locking arm 32, the concave frusto-conical surface of the recess 42 of the locking arm 32 (best seen in FIGS. 3 and 6) fits closely against the convex frusto-conical surface 64 of the tip 62 of the jack plug 60. The two frusto-conical surfaces 42, 64 (one being convex and the other being concave) correspond closely in shape and this provides an effective locking mechanism preventing withdrawal of the jack plug 60 from the locking jack plug socket 16.

As best seen in FIGS. 3 and 8, a bracing rib 66 extends upwardly from the bottom wall of the casing bottom 10 and this bracing rib 66 serves to prevent downward movement of the jack plug 60 which would otherwise reduce the effectiveness of the locking of the jack plug 60 within the locking jack plug socket 16. It will be appreciated that additional bracing ribs may be provided, either extending upwardly from the casing bottom 10, or extending downwardly from the underside of the intermediate lid 12. In this way, any tilting of the jack plug 60 when engaged within the locking jack plug 16 may be prevented.

In order to unlock the locking jack plug socket 16, so as to allow removal of the jack plug 60, the control screw 34 is rotated in an anticlockwise direction whereupon the two cam surfaces 50, 54 move against each other back into the unlocking position shown in FIGS. 5 and 8. This causes a small upward movement of the locking arm 32 which is sufficient to allow withdrawal of the jack plug 60. At the rotational position of the control screw 34 shown in FIGS. 5 and 8, no further anticlockwise rotation of the control screw 34 is possible due to contact between two additional stop surfaces (not shown).

As best seen in FIGS. 3 and 5, the jack plug 60 is of a type referred to as TRS. In other words, the tip 62 forms a first electrical contact, a ring 68 forms a second electrical contact and a sleeve 70 forms a third electrical contact. As best seen in FIG. 3, the locking jack plug socket 16 has first, second and third electrical contacts 72, 74, 76. The first electrical contact 72 forms an electrical contact with the tip 62. The second electrical contact 74 forms an electrical connection with the ring 68 and the third electrical contact 76 forms an electrical connection with the sleeve 70. Each one of the first, second and third electrical contacts 72, 74, 76 is spring loaded urging the electrical contacts 72, 74, 76 against the corresponding part of the jack plug 60. The electrical contacts 72, 74, 76 are in electrical connection with the electrical connectors on the underside of the connection plate 30.

The upper surface of the intermediate lid 12 is shown in FIG. 9. FIG. 9 also shows two bolts 80 which pass through respective holes in the intermediate lid 12 and are received in the support bosses 22 in order to fix the intermediate lid 12 securely against the casing bottom 10. As seen in FIG. 9, the intermediate lid 12 has three bayonet type slots 82 which cooperate with three corresponding bayonet projections (not shown) on the underside of the outer lid 14 in order to fix the outer lid 14 to the casing bottom 10. The intermediate lid 12 also has an aperture 84 which corresponds in position with the truncated pyramid 46 of the control screw 34 so that the security key can be passed through the aperture 84 to operate the control screw 34.

A slot 86 is also provided in the intermediate lid 12 to facilitate lifting of the intermediate lid 12 out of the casing bottom 10.

In operation, the security device is fixed to a fixture using the attachment bosses 20 as described above. In this example, the security device is used to secure a pair of headphones on retail display. The jack plug 60 of the headphones is inserted into the locking jack plug socket 16. A retail assistant then removes the outer lid 14 by rotating the outer lid 14 so as to reveal the intermediate lid 12. There is no need to remove the intermediate lid 12. The retail assistant uses the security key to rotate the control screw 34 in a clockwise direction which causes the locking arm 32 to move from the release position to the locking position as described above. The jack plug 60 is now locked in the locking jack plug socket 16. The retail assistant replaces the outer lid 14.

A potential customer is now able to listen to music through the headphones. In order to do this, a connecting cable (not shown) having a jack plug at each end is used. One of the jack plugs of the connecting cable is inserted into the standard jack plug socket 18 of the security device. The other jack plug of the connecting cable is inserted into the customer's MP3 player or mobile phone. Electrical signals carried by the connecting cable to the standard jack plug socket 18 are passed to the locking jack plug socket 16 and the music can be heard in the headphones. The locking of the jack plug 60 in the locking jack plug socket 16 prevents theft of the headphones.

It will be appreciated that the security device need not be as described above and many adaptations may be made while remaining within the scope of the appended claims.

For example, while the locking mechanism described above has been found to be very effective, any locking mechanism capable of holding a jack plug within a locking jack plug socket may be used.

In addition, it is not necessary to provide a standard jack plug socket 18. Instead, the security device may be provided with a jack plug of its own connected to the locking jack plug socket 16 by a cable fixed to the casing. The jack plug of the security device can then be simply inserted into the MP3 player or mobile phone of the customer.

Alternatively, the security device could be provided with any other type of input, such as a USB socket or USB plug.

1. A security device for securing a jack plug during retail display of a product fitted with a jack plug, the security device comprising: a jack plug socket for engagement with a jack plug and operable to lock a jack plug in said engagement so as to prevent withdrawal of the jack plug, an input for receiving electrical signals, the input being electrically connected to the jack plug socket so that electrical signals received at the input are transmitted to the jack plug socket for transmission of the electrical signals from the jack plug socket to a jack plug locked in engagement within the jack plug socket and for onward transmission of the electrical signals to a product connected to the jack plug, and an attachment for attaching the security device to a fixture, the jack plug socket comprising a locking member moveable between a locking position and a release position for release of a jack plug from the jack plug socket, the locking member being lockable in the locking position in engagement with a tip of a jack plug to effect said locking of the jack plug in said engagement with the jack plug socket, and wherein the jack plug socket also comprises a rotatable control member which interacts with the locking member, the rotatable control member being rotatable between a first stop at which the locking member is locked in the locking position and a second stop at which the locking member is in the release position.

2. A security device according to claim 1, further including a housing, the jack plug socket being provided in the housing and the attachment allowing attachment of the housing to a fixture.

3. (canceled)

4. A security device according to claim 1, wherein the locking member has a concave frusto-conical surface and wherein said engagement between the locking member and the tip of the jack plug comprises engagement between the concave frusto-conical surface of the locking member and a corresponding convex frusto-conical surface of the tip of the jack plug.

5. (canceled)

6. A security device according to claim 4, wherein the locking member has a first end and a second end, the first end being pivoted and the second end interacting with the rotatable control member, the concave frusto-conical surface being intermediate the first and second ends.

7. A security device according to claim 1, wherein the locking member and the rotatable control member have respective cam surfaces which interact so that rotation of the rotatable control member from the first stop to the second stop moves the locking member from the locking position to the release position and rotation of the rotatable control member from the second stop to the first stop moves the locking member from the release position to the locking position.

8. A security device according to claim 1, further comprising a security key, wherein the rotatable control member has a formation for engagement with the security key so that the rotatable control member can be rotated by the security key between the first and second stops.

9. A security device according to claim 2, wherein the rotatable control member and the locking member are contained within the housing.

10. A security device according to claim 2, wherein the input is a further jack plug socket provided in the housing.

11. A security device according to claim 1, wherein the input is a jack plug for receiving electrical signals from an electrical device.

12. A security device according to claim 11 and including a housing, the jack plug socket being provided in the housing and the attachment allowing attachment of the housing to a fixture, wherein the input jack plug is connected to the housing by a flexible cable.

13. A security device according to claim 1 in combination with a jack plug lockable in engagement with the jack plug socket.

14. A method of securing a jack plug during retail display of a product fitted with a jack plug, comprising providing a product fitted with a jack plug, providing a security device according to claim 1, securing the security device to a fixture, locking the jack plug in engagement with the security device.

15-17. (canceled)

18. A security device according to claim 6, wherein the locking member and the rotatable control member have respective cam surfaces which interact so that rotation of the rotatable control member from the first stop to the second stop moves the locking member from the locking position to the release position and rotation of the rotatable control member from the second stop to the first stop moves the locking member from the release position to the locking position.
